(19) United States
(12) Patent Application Publication
(10) Pub. No.: US 2016/0158651 A1
(43) Pub. Date: Jun. 9, 2016

(54) METHOD AND SYSTEM FOR A GAMING MOBILE SOFTWARE APPLICATION DRIVEN BY USER CONTENT

(71) Applicant: Sierra A. Myres, Naples, FL (US)

(72) Inventor: Sierra A. Myres, Naples, FL (US)

(21) Appl. No.: 14/560,234

(22) Filed: Dec. 4, 2014

(51) Int. Cl. A63F 13/63; A63F 13/87; A63F 9/00

(52) U.S. Cl. CPC A63F 13/63; A63F 9/0098; A63F 13/87

(57) ABSTRACT

An online multi-user gaming software application wherein players are required to solve puzzles by guessing a correct answer. The puzzles are preferably structured like games such as charades, Pictionary, name that tune and so forth, wherein one or more players are presented with a puzzle created using various forms of media. The puzzles may include clues that are in the form of one or more videos, pictures, drawings, music, sound clips, written clues and so forth, which are posted to a central database that is accessible by individuals using the software application of the present invention.

### FIELD OF THE INVENTION

This invention relates to games and mobile software applications in general and in particular to online games playable on mobile devices wherein content of the game is generated by players themselves and then disseminated to third parties through social media by sending invitations to the third parties to become members and thus, additional players.

### BACKGROUND OF THE INVENTION

Conventional online games attempt to attract new players by offering a variety of incentives. For example, a game may reward players for achieving certain goals or levels, for winning a game, for performing tasks within a game and so on, that is, in some cases a provider of an online game seeks to increase the number of players going to and playing an online game, and provides various incentives that go along with a game in order to realize an increase in players and gaming time. The greater number of players a game can attract and retain, the greater success the provider of the game will achieve by selling the game, selling upgrades to the game and/or selling advertising within the game.

Providers of conventional online games also attempt to increase the number of players using social media. However, such conventional games require players to devote an inordinate amount of time to developing an online character and/or an online world in order to play the game, thus conventional online games are a turn off for many individuals who do not want to make a large investment of their time into such a game.

Based on these factors, conventional online games have two problems. The first problem is that they are too time consuming and do not attract a large audience of players who may want to have control of their level of involvement in the game and/or not devote a large amount of time in the game. The second problem is that the games are not user generated or personalized to a group of potential players. Thus, when an individual receives an invitation to take part in the game, he or she does not feel any personal advantage to playing the game. For example, if an individual receives an invitation to take part in a simulation game vs. a quick puzzle, the individual will be much more likely to attempt to solve one or more puzzles, especially if those puzzles were prepared by a friend.

Therefore, a need exists for a system and method for an online multi-user gaming software application in which various solvable puzzles are generated by users and then invitations are sent to one or more individuals inviting the one or more individuals to solve the puzzle using the software application of the present invention.

The relevant prior art includes the following references:

| Pat. No. | | |
|---|---|---|
| (U.S. Patent References) | Inventor | Issue/Publication Date |
| 2009/0325661 | Gross | Dec. 31, 2009 |
| 2009/0325696 | Gross | Dec. 31, 2009 |
| 8,465,355 | Liang | Jun. 18, 2013 |
| 2012/0044319 | Thompson | Feb. 23, 2012 |
| 7,887,058 | Ritter et al. | Feb. 15, 2011 |
| 6,935,945 | Orak | Aug. 30, 2005 |
| 7,707,251 | Birch | Apr. 27, 2010 |
| 8,727,846 | McGovern et al. | May 20, 2014 |
| 2013/0084976 | Kumaran et al. | Apr. 4, 2013 |

### SUMMARY OF THE INVENTION

The primary object of the present invention is to provide an online multi-user gaming software application in which various solvable puzzles are generated by users and invitations are sent to one or more individuals inviting them to solve the puzzle using the software application of the present invention.

An additional object of the present invention is to provide an online multi-user gaming software application that grows organically by building a database of user created content.

An additional object of the present invention is to provide an online multi-user gaming software application that grows organically by attracting users through the use of user created content to attract potential players through social media.

An additional object of the present invention is to provide an online multi-user gaming software application capable of attracting a large base of players who will play the game for long or short periods of time depending on the number of puzzles each player attempts to solve during each play period rather than a small base of players who play the game for prolonged periods of time, as is typical with conventional simulation games.

The present invention fulfills the above and other objects by providing an online multi-user gaming software application wherein players are required to solve puzzles by guessing a correct answer. The puzzles are preferably structured like games such as charades, Pictionary, name that tune and so forth, wherein one or more players are presented with a puzzle created using various forms of media. The puzzles may include clues that are in the form of one or more videos, pictures, drawings, music, sound clips, written clues and so forth, which are posted to a central database that is accessible by individuals using the software application of the present invention. For example, a user may take a video of herself or himself acting out clues or take pictures of different objects that are used as clues based on the individual's chosen answer in a predetermined category. Then, the user may post the puzzle to the central database and send invitations or notifications to others through various social media sites to try to solve his or her puzzle. Players may earn points based on time and difficulty ratings of each puzzle. For example, players may choose specific themes, such as animals, movies, television shows, music and so forth for each puzzle he or she creates.

A benefit of the present invention is attracting players through the use of user-generated content to invite friends and acquaintances of the creator of the puzzle to attempt to solve the puzzle. After individuals have downloaded the software application of the present invention, they may solve other puzzles stored in the service provider's database, create their own puzzles and/or invite others to play.

Play may be formatted in several different ways between group play and individual play. For example, individual players may access puzzles saved in the provider's central database that were created by other players they know or players they do not know. The individual player may play for his or her own enjoyment and/or play for points that allow the individual player to be ranked against other individual players. Individual players may also join groups and compete against other individual players racing each other to solve puzzles within predetermined time limits and/or maybe ranked on a point system based on various factors. Groups may be made up of individual players who know each other and/or formed by sending invites to known players and/or potential players through social media sites. Potential players may include individuals who have not already downloaded the software application of the present invention and/or created an account with the provider to play. Each player has the capability of creating his or her own puzzles and then inviting others to solve those puzzles.

The game may have various sets of rules depending on if a player is playing individually, in a group and/or against other players. For example, in group play each player may takes turns guessing a sent puzzle or puzzle selected from the game networking system's database. If a player guesses right, then his or her name may appear on the other players' user devices with points awarded to each player at the end of a predetermined time limit. The time limit it takes to solve a puzzle will be able to be customized in a settings menu of the game before the game starts. The player to initiate play or host may determine time parameters in which puzzles may be solved. Players may attempt to solve a puzzle at the same time or take turns wherein the order of players may be randomized as to who goes first.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a schematic diagram showing an online environment in which the system and method of the present invention operates;

FIG. 2 is a flow chart showing the steps of an individual creating an account with the game networking system and playing the online game of the present invention; and

FIG. 3 is a flow chart showing the steps of a player creating a puzzle for use in the game of the present invention.

### DESCRIPTION OF THE PREFERRED EMBODIMENTS

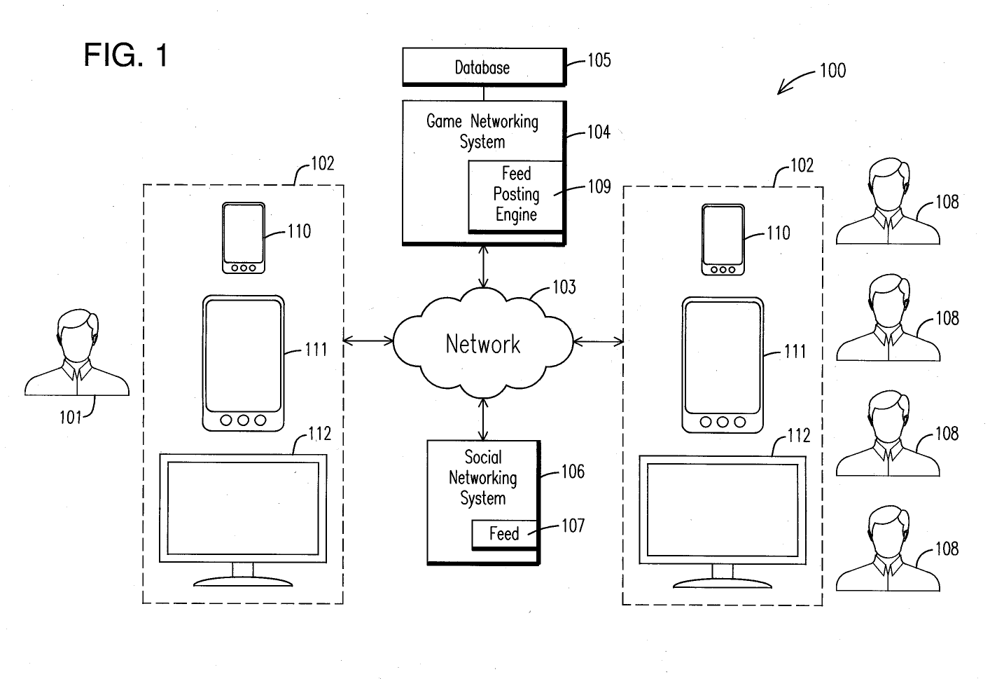

With reference to FIG. 1, a schematic diagram showing an online environment in which the system and method of the present invention operates is illustrated. The system and method 100 may comprise a first player 101 associated with a user device 102, a network 103 that provides access to the software application of the present invention through a game networking system 104 and database 105 of puzzles. A social networking system 106 supports and/or provides one or more online feeds 107 that connect to the first player's network of friends 108, each associated with a user device 102, who may already be members of the networking gaming system 106 or be invited to join the game networking system 106 and become players using a feed posting engine 109.

The example components of the system 100 may be connected directly or via the network 103, which may be any suitable network. In various example embodiments, one or more portions of the network 103 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, any other type of network, or a combination of two or more such networks.

Although FIG. 1 illustrates a particular example or arrangement of the first player 101 and friends 108, the user devices 102, the network 103, the game networking system 104, the social networking system 106, this disclosure includes any suitable arrangement or configuration of the first player 101 and friends 108, the user device 102, the network 103, the game networking system 104, the social networking system 106.

The user device 102 may be any suitable computing device, such as a smart phone 110, a tablet 111, a laptop 112, and/or any other device suitable for playing an online game, such as other mobile devices, gaming devices, computing devices and so forth. The user device 102 may access the social networking system 106 or the game networking system 104 directly, via the network 103, or via a third-party system. For example, the user device 102 may access the game networking system 104 via the social networking system 106, or vice versa. It should be noted that the functionality described herein may reside partially or wholly on any one device or be distributed across several devices.

In some example embodiments, the social network system 106, via a social network service may provide and/or support one or more feeds 107, such as streams of content accessible to members, viewers, and/or other users of the social network service. In some cases, the social networking system 106 may provide a closed feed that is viewable and/or otherwise accessible to members of the social network service.

In some example embodiment, the game networking system 104 includes a feed posting engine 109 configured to post feed items by the game networking system 104 to one or more feeds, such as the feed 107 supported by the social networking system 106.

The feed posting engine 109 may include various components, modules, and/or engines that cause external feeds 107 to post feed items associated with actions performed within the game networking system 104, such as the creation of a new puzzle by a player. The feed posting engine 109 may also receive and/or access indications or information associated with actions or events within online games that may trigger a post of a feed item or other information to a feed. Example events and/or performed actions include a player achievements, such as a player solving a puzzle.

In response to the action and/or event, the feed posting engine 109 may perform a variety of methods or processes in order to post, or cause to be posted, feed items, including identifying and/or selecting appropriate and/or suitable feeds at which to post feed items, generating the feed items and information contained by the feed items, configuring the feed items based on-the services providing the feeds, and so on.

The feed posting engine 109, therefore, may enable the game networking system 104 to post feed items via a single action to various online locations, such as Facebook, Twitter, Instagram, Rich, Tumbir, Google+, and so on, Twitter, Instagram, Vine and so forth, thereby facilitating an engagement between the game and players and potential players of invitations to play, invitations to play puzzles created by friends, player achievements and so forth.

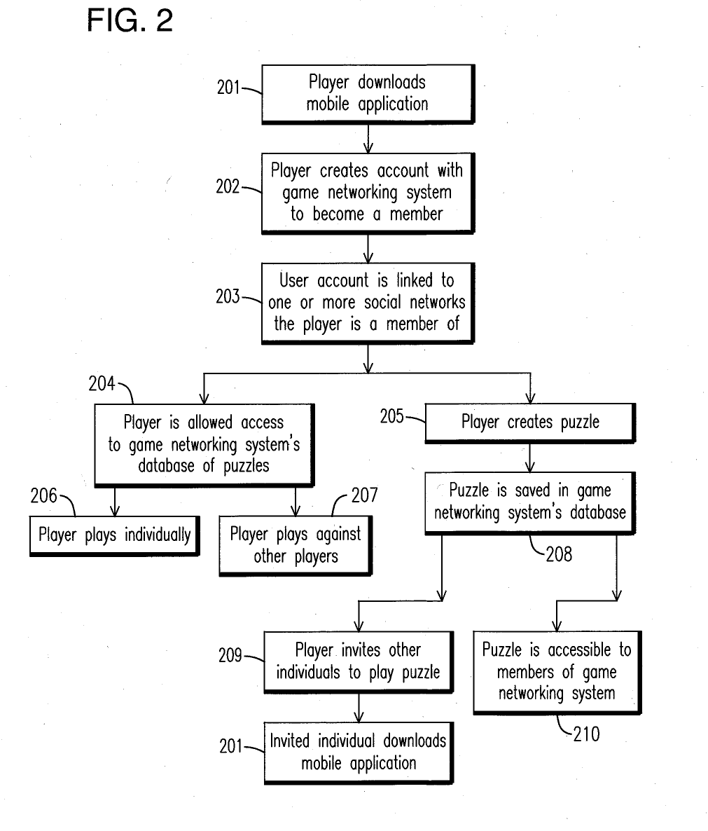

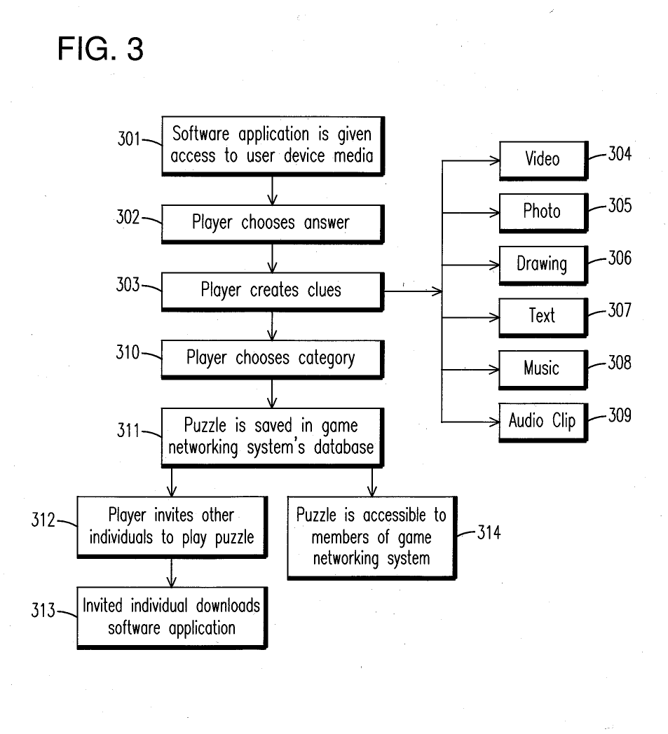

With reference to FIG. 2, a flow chart showing the steps of an individual creating an account with the game networking system and playing the online game of the present invention is illustrated. First, an individual downloads the mobile application of the present invention from the game networking system over a network to a user device 201. Then, the player creates a user account with the game networking system, thereby becoming a member of the game networking system 202. Next, the player's user account may be linked to one or more social networks that the player is a member of 203 and game network system is given access to the players network of friends. Then, the player may participate in the game networking system by accessing the game networking system's database of saved puzzles 204 and/or by creating his or her own puzzle 205. If the at the player chooses to play and solve puzzles 204, then the player may play individually 206 or play against other players 207. If the player chooses create his or her own puzzle 205 (which is illustrated in FIG. 3), then the puzzle is saved to the game networking system's database 208. Then, the player may invite other individuals to play his or her particular puzzle 209 through social media and/or the game networking system. The invited individual may then download the software application in order to be able to solve the created puzzle 201 and repeat steps 201-203. The created puzzle may also be made accessible to other members of the game networking system 210.

With reference to FIG. 3, a flow chart showing the steps of a player creating a puzzle for use in the game of the present invention is illustrated. First, the software application of the present invention is linked and/or given access to the memory and/or media, such as camera, recording and so forth 301. Then, player chooses an answer to the puzzle 302. Next, the player creates clues and/or hints other players must use to determine the correct answer 303. Said clues may be video clues 304, photo clues 305, drawing clues 306, text clues 307, audio clues (such as music clues 308 and audio clip clues 309), and so forth. The puzzle is then preferably placed into a category 310 so that it may be searchable within the game networking system's database by other players. Categories may include different topics or subjects such as sports, movies, TV shows, music, art, history, animals, pop culture, and so forth. Then, the puzzle is saved to the game networking system's database 311. Next, the player may invite other players and/or potential players to attempt to solve his or her puzzle 312. Invitations may be sent through the game networking system itself and/or through a variety of social networking system feeds as invitations to friends and contacts. If an invitee is already a member of the game networking system, then he or she may proceed with attempting to solve the puzzle. If the invitee is not a member of the game networking system, than he or she may download the software application 313 and proceed with steps 201-203 of FIG. 2. The puzzled may also be accessed by other players and members of the game networking system 314. Puzzles and other games stored in the game networking system's database may be search by categories or using other filters such as the creator of the puzzle's name, which allows individuals to search for puzzles created by acquaintances and friends.

Puzzles are preferably structured like games' such as charades, Pictionary, name that tune, word jumbles and so forth. For example, a player may include puzzles wherein clues include a video of clues being drawn, video of clues being acted out, music clips, video clips, pictures of places or things, riddles and so forth.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification and drawings.

Having thus described my invention, I claim:

1. A method for playing an online gaming software application comprising the steps of:
a. a first player downloading a mobile application from a game networking system over a network to a user device;
b. said first player creating a user account with the game networking system;
c. linking the user account to one or more of the first player's social networks;
d. creating one or more puzzles to be played on the game networking system; and
e. inviting one or more friends of the first player to solve said one or more puzzles on the game networking system.

2. The method of claim 1 further comprising the step of:
saving the one or more puzzles in a database controlled by the game networking system.

3. The method of claim 2 further comprising the step of:
the one or more saved puzzles are made available for play to other players having user accounts with the game networking system.

4. The method of claim 1 further comprising the step of:
the one or more invited friends downloading the software application in order to be able to solve the one or more created puzzles.

5. The method of claim 4 further comprising the step of:
at least one of the one or more invited friends creating a user account with the game networking system.

6. The method of claim 1 wherein:
said one or more puzzles includes at least one clue that is a video clue.

7. The method of claim 1 wherein:
said one or more puzzles includes at least one clue that is a photo clue.

8. The method of claim 1 wherein:
said one or more puzzles includes at least one clue that is a drawing clue.

9. The method of claim 1 wherein:
said one or more puzzles includes at least one clue that is a text clue.

10. The method of claim 1 wherein:
said one or more puzzles includes at least one clue that is an audio clue.

11. A system for playing an online gaming software application comprising:
a mobile application being downloaded from a game networking system over a network to a user device by a first player;
a user account being created with the game networking system by the first player;
the user account being linked to one or more of the first player's social networks;
one or more puzzles being created to be played on the game networking system; and
one or more friends of the first player being invited to solve said one or more puzzles on the game networking system.

12. The system of claim 1 further comprising:
the one or more puzzles being saved in a database controlled by the game networking system.

13. The system of claim 2 further comprising:
the one or more saved puzzles being made available for play to other players having user accounts with the game networking system.

14. The system of claim 1 further comprising:
the one or more invited friends downloading the software application in order to be able to solve the one or more created puzzles.

15. The system of claim 4 further comprising:
at least one of the one or more invited friends creating a user account with the game networking system.

16. The system of claim 1 wherein:
said one or more puzzles includes at least one clue that is a video clue.

17. The system of claim 1 wherein:
said one or more puzzles includes at least one clue that is a photo clue.

18. The system of claim 1 wherein:
said one or more puzzles includes at least one clue that is a drawing clue.

19. The system of claim 1 wherein:
said one or more puzzles includes at least one clue that is a text clue.

20. The system of claim 1 wherein:
said one or more puzzles includes at least one clue that is an audio clue.
